(19) United States
(12) Patent Application Publication
(10) Pub. No.: US 2012/0077950 A1
(43) Pub. Date: Mar. 29, 2012

(54) Compound Suitable as Polymeric Dispersant

(75) Inventors: Katty Darragas, Oudenaarde (BE); Koen Gebruers, Pellenberg (BE)

(73) Assignee: Huntsman International LLC, The Woodlands, TX (US)

(21) Appl. No.: 13/376,625

(22) PCT Filed: May 21, 2010
(86) PCT No.: PCT/EP2010/057018

§ 371 Date: Dec. 7, 2011

(30) Foreign Application Priority Data
Jun. 19, 2009 (EP) 09163245.5
Nov. 18, 2009 (EP) 09176321.9

(51) Int. Cl. C08G 18/06

(52) U.S. Cl. 528/78

(57) ABSTRACT

A compound according to the present invention is obtainable by reacting a polyisocyanate with a monoalkylether of a polyoxyalkylenemonoamine, in such an amount that substantially no free isocyanate groups are present in the component. The polyisocyanate itself is an adduct of two polyisocyanate molecules with one isocyanate reactive molecule chosen from the group consisting of a polyoxyalkylene diamine, a polyoxyalkylene diol, a polyoxyalkylenealkanolamine, a polyester diamine, a polyester diol and a polyesteralkanolamine, the average molecular weight of the isocyanate reactive molecule being more than 1000.

The present invention relates to polymeric dispersants.

Dispersants being based upon combinations or polyisocyanate compounds and monoalkyl ethers of a polyoxyalkylenemonol are known from e.g. US2002/0042492, U.S. Pat. No. 4,079,028 and EP1106634A1.

Polymeric dispersants, i.e. dispersants having an average molecular weight of more than 1000 gram per mole, are dispersants suitable to disperse two different phases, e.g. liquid in liquid or solid in liquid.

According to the present invention, a compound, suitable as a dispersant, was designed, which is relatively cheap and easy, less complex to produce. The compound may have a molecular weight with limited deviation on its average, and suitable to be provided with a limited number of steps.

According to a first aspect of the present invention, a compound is provided, which compound is obtainable by reacting a polyisocyanate with a monoalkylether of a polyoxyalkylenemonoamine, in such an amount that substantially no free isocyanate groups are present in said compound, the polyisocyanate being an adduct of two polyisocyanate molecules with one isocyanate reactive molecule chosen from the group consisting of a polyoxyalkylene diamine, a polyoxyalkylene diol, a polyoxyalkylenealkanolamine, a polyester diamine, a polyester diol and a polyesteralkanolamine, the average molecular weight of said isocyanate reactive molecule being more than 1000.

Surprisingly it was found that the use of the amine groups of said monoalkylether of a polyoxyalkylenemonoamine to bind to the isocyanate groups of the polyisocyanate, thereby providing urea bonds, provides a compound suitable as dispersant, which is more resistant to hydrolysis and which is resistant to higher temperatures. In other terms, the hydrolysis stability and temperature stability is improved by using these urea bonds. The use of monoalkylethers of a polyoxyalkylenemonoamine further has as an advantage that the use of catalysts to bind the monoalkylether of a polyoxyalkylenemonoamine to the isocyanate groups can be avoided. Hence the presence of these catalysts, which are difficult to remove from the reaction mixture in which the compound according to the invention is prepared, if removable at all, is avoided. These catalysts, which typically are necessary to prepare alternative dispersants using monoalkylether of a polyoxyalkylenemonoalcohol bound to the isocyanate groups, result often in decomposition of the products made using the dispersant. Therefore, the possibility to avoid the presence of such catalysts in reaction mixtures for producing the compound according to the invention, results in more stable dispersions when the compound of the present invention is used in these dispersions as dispersant.

Hence the compound is an adduct of a monoalkylether of a polyoxyalkylenemonoamine with a polyisocyanate, which polyisocyanate itself is an adduct of two polyisocyanate molecules with one isocyanate reactive molecule comprising two isocyanate reactive groups.

Average molecular weight is expressed in gram per mole, unless otherwise indicated.

According to some embodiments, the two polyisocyanate molecules may be identical.

According to some embodiments, the two polyisocyanate molecules may be two diisocyanate molecules.

According to some embodiments, the polyisocyanate molecules may be MDI molecules.

The diisocyanate molecule may be an aromatic-based diisocyanate, in particular toluene diisocyanate (TDI) or methylene diphenyl diisocyanate (MDI), such as 4,4′MDI, 2,4′MDI, 2,2′MDI and any mixture of those MDI variants. Methylene diphenyl diisocyanate (MDI), such as 4,4′MDI, 2,4′MDI, 2,2′MDI and any mixture of those MDI variants is preferably used.

The diisocyanate molecule may be an aliphatic-based diisocyanate, such as hexamethylene diisocyanate (HDI), optionally a cycloaliphatic-based diisocyanate, such as isophorone diisocyanate (IPDI) and diisocyanatodicyclohexylmethane (H12MDI).

Typically, the polyisocyanate is an adduct of diisocyanate molecules with isocyanate reactive molecules chosen from the group consisting of a polyoxyalkylene diamine, a polyoxyalkylene diol, a polyoxyalkylenealkanolamine, a polyester diamine, a polyester diol and a polyesteralkanolamine, which diisocyanate and isocyanate reactive molecule having two isocyanate reactive groups, are reacted in a molar ratio of isocyanate reactive molecule over diisocyanate molecules of about 1:2.

In the alternative, the polyisocyanate molecule may be a triisocyanate, such as trimerised HDI. The remaining isocyanate of the trimers, after reaction with the polyoxyalkylene diamine, a polyoxyalkylene diol, a polyoxyalkylenealkanolamine, a polyester diamine, a polyester diol and a polyesteralkanolamine, thereafter is to be blocked by additional monoamine, to provide a non-reactive compound.

According to some embodiments, the monoalkylether of a polyoxyalkylenemonoamine may have a molecular weight of more than 1000.

For the compound, a molecular weight of up to or even more than 6000 may be obtained.

The isocyanate reactive molecule is preferably a polyoxyalkylene diamine, a polyoxyalkylene diol or a polyoxyalkylenealkanol amine. These polyoxyalkylene diamines, polyoxyalkylene diols and polyoxyalkylenealkanol amines comprise a polyoxyalkylene group.

The monoalkylethers of a polyoxyalkylenemonoamine also comprise a polyoxyalkylene group.

The polyoxyalkylene groups, either from the monoalkylethers of the polyoxyalkylenemonoamine or from the isocyanate reactive molecule, may be provided by polymerization of oxyalkylene components, e.g. ethylene oxide, propylene oxide, oxetane, butylene oxide, epoxybutane and tetrahydrofuran, or mixtures thereof. In case of more than one different oxyalkylene component, the various oxyalkylenes may be random or block copolymerized, e.g. block-copolymers of ethylene oxide and propylene oxide.

According to some embodiments of the present invention, the polyoxyalkylene groups from the monoalkylethers of the polyoxyalkylenemonoamine may be block-copolymers of at least two different oxyalkylene groups, e.g. block-copolymers of ethylene oxide and propylene oxide.

According to some embodiments of the present invention, the polyoxyalkylene groups from the monoalkylethers of the polyoxyalkylenemonoamine are random copolymers of at least two different oxyalkylene groups, e.g. random copolymers of oxyethylene and oxypropylene groups. The polyoxyalkylene groups from the monoalkylethers of the polyoxyalkylenemonoamine preferably are polyoxyalkylene groups comprising, optionally consisting of oxyethylene and oxypropylene groups, which may be random polymerized.

It was found that the random polymerization has the effect of reducing the melt temperature of the compound according to the present invention in comparison to compounds according to the invention having only block-copolymerized oxyethylene and oxypropylene groups in the polyoxyalkylene groups from the monoalkylethers of the polyoxyalkylenemonoamine.

Preferably the polyoxyalkylene group of the isocyanate reactive component is different from the oxyalkylene groups of the monoalkylethers of the polyoxyalkylenemonoamine. Most preferably the hydrophilicity of the molecule being the monoalkylether of the polyoxyalkylenemonoamine on the one hand, and the hydrophilicity of the isocyanate reactive molecule is significantly different, i.e. having a significantly different HLB value. HLB refers to the Hydrophilic/Lipophilic balance.

The HLB value of a molecule is a value in the range of 0 to 20, which is calculated by the formula:

20* MW_{EO}*N_{EO}/MW_{molecule},

wherein MW_{EO}=Mole weight of ethylene oxide=44 g N_{EO}=number of moles of EO in the molecule MW_{molecule}=Mole weight of the molecule

The higher the HLB value is, the more hydrophilic a material is.

According to some embodiments, the compound may have an HLB value in the range of 11 to 15.

Preferably the HLB value of the compound is in the range of 12 to 14, e.g. 13.

The HLB value of this monoalkylethers of a polyoxyalkylenemonoamine may range preferably from 2 to 18.6.

Typically, but not necessarily, the hydrophilicity of the monoalkylethers of a polyoxyalkylenemonoamine is relatively high, i.e. having an HLB value in the range of 10 to 19. Preferably more hydrophilic oxyalkyl components, most preferred ethylene oxide, are used to provide, at least part, of the polyoxyalkylene group. In case of use of more than one monoalkylether of a polyoxyalkylenemonoamine, the hydrophilicity of these components are preferably similar, even identical. Optionally, the polyisocyanate may be reacted with two different polyoxyalkylenemonoamine, e.g. two different polyethermonoamines, that have a different molar weight (MW), but the same high HLB value, e.g. JEFFAMINE M-1000 having a MW of about 1000 g/mol and JEFFAMINE M-3000 having a MW of about 3000 g/mol, both having an HLB value of 17. Variations in the MW of the final compound, e.g. by using one or more different polyoxyalkylenemonoamine may affect the dispersion and the compatibilization properties. Preferably however, only one monoalkylether of a polyoxyalkylenemonoamine is used to react with the isocyanate groups of the polyisocyanate, preferably a diisocyanate.

The HLB value of the isocyanate reactive molecule may be in the range of 4 to 14. Typically, but not necessarily, the hydrophobicity of the isocyanate reactive molecule is higher than the hydrophobicity of the monoalkylethers of a polyoxyalkylenemonoamine. Preferably more hydrophobic, or less hydrophilic, oxyalkylene components, most preferred propylene oxide, tetrahydrofuran or tetramethylene oxide, are used to provide, at least part of the polyoxyalkylene group.

The HLB value of the isocyanate reactive molecule may be 0.

Most preferred is a compound according to the present invention, wherein the polyalkylene group of the isocyanate reactive component is a polypropyleneoxide group and/or polytetramethylene ether glycol, whereas the polyalkylene group of the monoalkylethers of a polyoxyalkylenemonoamine is an alkyleneoxide group being the adduct of ethylene oxide, optionally in combination with propylene oxide, tetrahydrofuran and/or tetramethylene oxide.

According to some embodiments, the polyoxyalkylene group of the monoalkylether of a polyoxyalkylenemonoamine may be ethylene oxide based polyoxyalkylene group. The monoalkylether of a polyoxyalkylenemonoamine may only comprise ethylene oxide for providing the oxyalkylene components in the polyoxyalkylene group. According to some embodiments, the polyoxyalkylene group of the isocyanate reactive molecule may be a propylene oxide based polyoxyalkylene group.

The polyoxyalkylene group of the isocyanate reactive molecule may only comprise propylene oxide for providing the oxyalkylene components in the polyoxyalkylene group. According to some embodiments, the polyoxyalkylene group of the isocyanate reactive molecule may be a tetramethylene oxide based polyoxyalkylene group.

The polyoxyalkylene group of the isocyanate reactive molecule may only comprise tetramethylene oxide for providing the oxyalkylene components in the polyoxyalkylene group.

Most preferred, the isocyanate reactive molecule and the monoalkylethers of a polyoxyalkylenemonoamine have a high molecular weight, typically more than 1000. Hence compounds according to the present invention may have a molecular weight of more than 2000, such as more than 3000, such as even more than 4000 or more than 5000 can be provided.

It was found that some compounds according to the present invention, in particular the compounds having an isocyanate reactive molecule and the monoalkylethers of a polyoxyalkylenemonoamine having significantly different hydrophobicity, may function as a polymeric dispersant, allowing to disperse one phase into an other, i.e. dispersing a liquid in a liquid or a solid in a liquid. Such compounds according to the present invention with higher molecular weight, e.g. with an over all molecular weight of more than 3000, and with an isocyanate reactive component and two monoalkylethers of a polyoxyalkylenemonoamine, each having a molecular weight above 1000, show this dispersing property even more.

According to a second aspect of the present invention, a compound according to the first aspect of the present invention is used as a dispersant. The compound may be used for dispersing a first liquid in a second liquid, and/or for dispersing a solid in a liquid.

According to a third aspect of the present invention, a compound according to the first aspect of the present invention is used as a plasticizer. The compound may be used for plasticizing a thermoplastic material or thermoplastic polymer, such as e.g. polyvinylchloride (PVC), and possibly engineering plastics such as nylon and polyester. The compounds may not only be an alternative for phtalates plasticisers, but also for other existing plasticizers such as adipate and polymeric plasticizer.

The independent and dependent claims set out particular and preferred features of the invention. Features from the dependent claims may be combined with features of the independent or other dependent claims as appropriate.

The above and other characteristics, features and advantages of the present invention will become apparent from the following detailed description which illustrate, by way of example, the principles of the invention. This description is given for the sake of example only, without limiting the scope of the invention.

The present invention will be described with respect to particular embodiments.

It is to be noticed that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, references to “one embodiment” or “an embodiment” are made. Such references indicate that a particular feature, described in relation to the embodiment, is included in at least one embodiment of the present invention. Thus, appearances of the phrases “in one embodiment” or “in an embodiment” in various places throughout this specification are not necessarily all referring to the same embodiment, though they could. Furthermore, the particular features or characteristics may be combined in any suitable manner in one or more embodiments, as would be apparent to one of ordinary skill in the art.

When hereinafter MW is indicated, this term refers to the average molecular weight of the component indicated, expressed in gram per mole.

### Example I

A so-called prepolymer, being the adduct of two MDI molecules and a polypropylene glycol, was reacted with a polyether monoamine

The prepolymer, being an aromatic based diisocyanate, hence having isocyanate functionality 2, has an NCO value of 10.2% and an equivalent weight of 412 g/eq, and comprises a polymer having polypropylene glycol between the two MDI-based extremities. Since the prepolymer comprises no ethylene oxide groups, the HLB value is 0.

The polyether monoamine has a MW of about 3000 and comprises on average 8 PO groups and 58 EO groups per molecule. The HLB value is 17.1.

The prepolymer and the polyether monoamine were charged to a 3-neck round bottom flask. The molar ratio of prepolymer to polyether monoamine is between 1 to 1.5 and 1 to 4, preferably between 1 to 1.9 and 1 to 2.1. The flask was fitted with a thermometer and an overhead stirrer. The reaction mixture was covered with a N₂-blanket. The mixture was stirred while maintained at 40-100° C., preferably 40-60° C. for 1-10 hours. For the resulting reaction mixture, an average MW of 6824 was found. The reaction mixture comprises the compound, being the adduct of the prepolymer and the polyether monoamine, having an HLB value of 14.9.

Additional to the adduct of the prepolymer and the polyether monoamine, an adduct of MDI and the polyether monoamine was present in the resulting reaction mixture.

### Example II

An alternative prepolymer, being the adduct of two H12MDI molecules and a polytetramethylether glycol, was reacted with a polyether monoamine

The prepolymer, being an aliphatic based diisocyanate, hence having isocyanate functionality 2, has an NCO value of 4.6 to 4.9% and an average equivalent weight of 887 g/eq, and comprises a polymer having polytetramethylene ether glycol between the two H12MDI-based extremities. Since the prepolymer comprises no ethylene oxide groups, the HLB value is 0.

The polyether monoamine has a MW of about 3000 and comprises on average 8 PO groups and 58 EO groups per molecule. The HLB value is 17.1.

The prepolymer and the polyether monoamine were charged to a 3-neck round bottom flask. The molar ratio of prepolymer to polyether monoamine is between 1 to 1.5 and 1 to 4, preferably between 1 to 1.9 and 1 to 2.1. The flask was fitted with a thermometer and an overhead stirrer. The reaction mixture was covered with a N₂-blanket. The mixture was stirred while maintained at 40-100° C., preferably 40-60° C. for 1-10 hours.

For the resulting reaction mixture, an average MW of 7770 was found. The reaction mixture comprises the compound, being the adduct of the prepolymer and the polyether monoamine, having an HLB value of 13.

Additional to the adduct of the prepolymer and the polyether monoamine, an adduct of H12MDI and the polyether monoamine was present in the resulting reaction mixture.

It is to be understood that although preferred embodiments and/or materials have been discussed for providing embodiments according to the present invention, various modifications or changes may be made without departing from the scope and spirit of this invention.

1. A compound obtainable by reacting a polyisocyanate with a monoalkylether of a polyoxyalkylenemonoamine, in such an amount that substantially no free isocyanate groups are present in said compound, said polyisocyanate being an adduct of two polyisocyanate molecules with one isocyanate reactive molecule, the isocyanate reactive molecule being chosen from the group consisting of a polyoxyalkylene diamine, a polyoxyalkylene diol, a polyoxyalkylenealkanolamine, a polyester diamine, a polyester diol and a polyesteralkanolamine, the average molecular weight of said isocyanate reactive molecule being more than 1000.

2. The compound according to claim 1, wherein said two polyisocyanate molecules are identical.

3. The compound according to claim 1, wherein said two polyisocyanate molecules are two diisocyanate molecules.

4. The compound according to claim 3, wherein said polyisocyanate molecules are MDI molecules.

5. The compound according to claim 1, wherein said compound has an average molecular weight of more than 6000.

6. The compound according to claim 1, wherein said monoalkylether of a polyoxyalkylenemonoamine has a molecular weight of more than 1000.

7. The compound according to claim 1, wherein the compound has an HLB value in the range of 11 to 15.

8. The compound according to claim 1, wherein said polyoxyalkylene group of the a monoalkylether of a polyoxyalkylenemonoamine is ethylene oxide based polyoxyalkylene group.

9. The compound according to claim 1, wherein the polyoxyalkylene groups from the monoalkylethers of the polyoxyalkylenemonoamine are random copolymers of at least two different oxyalkylene groups.

10. The compound according to claim 1, wherein the polyoxyalkylene groups from the monoalkylethers of the polyoxyalkylenemonoamine are block-copolymers of at least two different oxyalkylene groups.

11. The compound according to claim 1, wherein said isocyanate reactive molecule is chosen from the group consisting of a polyoxyalkylene diamine, a polyoxyalkylene diol and a polyoxyalkylenealkanolamine, said polyoxyalkylene group of the isocyanate reactive molecule is a propylene oxide based polyoxyalkylene group.

12. A dispersant comprising the compound of claim 1.

13. (canceled)

14. (canceled)

15. A plasticizer comprising the compound of claim 1.

16. (canceled)
